(19) United States
(12) Patent Application Publication
(10) Pub. No.: US 2021/0060787 A1
(43) Pub. Date: Mar. 4, 2021

(54) EDUCATION ASSISTING ROBOT AND CONTROL METHOD THEREOF

(71) Applicant: Wuyi University, Jiangmen (CN)

(72) Inventors: Chuanbo QIN, Jiangmen (CN); Zhenhui Yu, Jiangmen (CN); Junying Zeng, Jiangmen (CN); Fan Wang, Jiangmen (CN); Yinghong Ou, Jiangmen (CN); Wenjun Wu, Jiangmen (CN)

(21) Appl. No.: 16/806,717

(22) Filed: Mar. 2, 2020

(30) Foreign Application Priority Data
Aug. 29, 2019 (CN) 2019108104514

(51) Int. Cl. B25J 9/16; G06K 9/00; G06K 9/62; G06K 9/46; G06T 7/44; G06T 7/73

(52) U.S. Cl. CPC B25J 9/1697; B25J 9/1666; G06K 9/00288; G06K 9/00255; G06T 2210/12; G06K 9/6276; G06K 9/4642; G06T 7/44; G06T 7/74; G06K 9/00268

(57) ABSTRACT

Disclosed are an education assisting robot and a control method thereof. The method includes: capturing and recognizing students' faces from shot images, and checking students' attendance; and capturing a teacher's face from the shot images and identifying a target, and target-following the teacher. The role of a target character can be automatically distinguished from the images, and different actions can be made for different target characters, including attendance checking and target following, so as to provide more different response functions and reduce the workload of teachers.

### RELATED APPLICATIONS

This application claims the benefit of CN Patent Application No. 201910810451.4 filed Aug. 29, 2019 entitled EDUCATION ASSISTING ROBOT AND CONTROL METHOD THEREOF, the entirety of which is incorporated by reference herein.

### TECHNICAL FIELD

The present disclosure relates to the field of automatic robots, and in particular, to an education assisting robot and a control method thereof.

### BACKGROUND

Currently, one teacher manages multiple classes or multiple courses, and therefore has a heavy workload. To reduce the working pressure of teachers and improve their working efficiency, it is necessary to provide an intelligent education assisting robot to share the workload of the teachers. However, the robot needs to be manually controlled, so it also requires manpower, result in wasting of the manpower. In addition, if the robot cannot distinguish various roles, that is, teachers, students and other personnel, it cannot respond differently to different roles.

### SUMMARY

The present disclosure aims at providing an education assisting robot and a control method thereof to address at least one of the technical problems existing in the prior art, which can distinguish a target and realize automatic following of the target.

The technical solution adopted in the present disclosure to address its problem is as follows:

A control method of an education assisting robot is provided in a first aspect of the present disclosure, which comprises:

capturing and recognizing students' faces from shot images, and checking students' attendance; and

capturing a teacher's face from the shot images and identifying a target, and target-following the teacher.

The control method of an education assisting robot has at least the following beneficial effects: it can distinguish the roles of different targets from the shot images, and make different actions according to different roles. It can check attendance of students and target-follow teachers. Then, after the teachers are followed, more collaborative functions are implemented according to further instructions of the teachers, so as to assist the teachers' work.

According to the first aspect of the present disclosure, the capturing and recognizing students' faces from shot images, and checking students' attendance comprises:

receiving input student photos to create a student sign-in form;

shooting real-time images by a binocular camera;

capturing and recognizing students' faces from the shot images according to a deep face recognition algorithm; and

matching the recognized students' faces with the student photos of the student sign-in form to complete the attendance.

According to the first aspect of the present disclosure, the capturing and recognizing students' faces from the shot images according to a deep face recognition algorithm comprises:

texturing the images by using an LBP histogram and extracting face features;

performing SVR processing on the face features to obtain 2D-aligned 2D faces;

Deloni triangulating the faces based on key points of the 2D faces and adding triangles to edges of face contours;

converting the triangulated faces to 3D faces facing forward; and

obtaining student face recognition results after face representation, normalization and classification of the 3D faces.

According to the first aspect of the present disclosure, the capturing a teacher's face from the shot images and identifying a target, and target-following the teacher comprises:

constructing a 2D map;

capturing the teacher's face from the images shot by the binocular camera according to a deep face recognition algorithm and identifying the target;

inferring the position of the target in a next frame of an image from the position of the target in a previous frame of the image according to the images continuously shot by the binocular camera to create a motion trajectory of the target; and

performing local path planning and global path planning on the 2D map according to the motion trajectory of the target.

According to the first aspect of the present disclosure, the constructing a 2D map comprises:

acquiring motion attitude and peripheral images of the robot and extracting landmark information from the peripheral images; and

generating the 2D map according to the motion attitude of the robot and the landmark information.

According to the first aspect of the present disclosure, the inferring the position of the target in a next frame of an image from the position of the target in a previous frame of the image according to the images continuously shot by the binocular camera to create a motion trajectory of the target comprises:

generating multiple sample points uniformly in a bounding box of the position of the target in the previous frame of the image;

tracking the multiple sample points forward from the previous frame to the next frame of the image, and then tracking the multiple sample points backward from the next frame to the previous frame of the image, so as to calculate FB errors of the multiple sample points;

selecting half of the multiple sample points with small FB errors as optimal tracking points;

calculating, according to a coordinate change of the optimal tracking points in the next frame relative to the previous frame, the position and size of a bounding box of the position of the target in the next frame of the image; and

repeating the step of obtaining the bounding box of the position of the target in the next frame of the image from the bounding box of the position of the target in the previous frame of the image, to create the motion trajectory of the target.

According to the first aspect of the present disclosure, the inferring the position of the target in a next frame of an image from the position of the target in a previous frame of the image according to the images continuously shot by the binocular camera to create a motion trajectory of the target further comprises:

classifying image samples in the bounding box into positive samples and negative samples by three cascaded image element variance classifiers, a random fern classifier and a nearest neighbor classifier;

correcting the positive samples and the negative samples by P-N learning; and

generating the multiple sample points in the corrected positive samples.

According to the first aspect of the present disclosure, the local path planning specifically comprises:

obtaining a shape of an obstacle through detection of a distance from the obstacle by a laser sensor and image analysis by the binocular camera; and

identifying a travel speed and a travel direction by a dynamic window approach according to the distance from the obstacle and the shape of the obstacle; and

the global path planning specifically comprises:

defining multiple nodes in the 2D map; and

obtaining an optimal global path by searching for and identifying a target node directly connected to a current node and having the least travel cost with the current node until the final node is the target node.

According to the first aspect of the present disclosure, the control method of an education assisting robot further comprises:

connecting a course schedule library, the course schedule library comprising courses and course places corresponding to the courses; and

querying the course schedule library for a course of a corresponding teacher, and automatically traveling to the course place corresponding to the course by referring to a path planned on the 2D map.

An education assisting robot applied to the control method as described in the first aspect of the present disclosure is provided in a second aspect of the present disclosure, comprising an environment information collection module, a face information collection module, a motion module, a processor and a memory, wherein the memory stores control instructions, the processor executes the control instructions and controls the environment information collection module, the face information collection module and the motion module to perform the following steps:

capturing and recognizing students' faces from shot images, and checking students' attendance; and

capturing a teacher's face from the shot images and identifying a target, and target-following the teacher.

The education assisting robot has at least the following beneficial effects: it can distinguish the roles of different targets from the images shot by the face information collection module, and make different actions according to different roles. It can check attendance of students or control the motion module to move according to environment information collected by the environment information collection module to target-follow teachers. Then, after the teachers are followed, more collaborative functions are implemented according to further instructions of the teachers, so as to assist the teachers' work.

### BRIEF DESCRIPTION OF THE DRAWINGS

The present disclosure is further described below with reference to accompanying drawings and examples.

FIG. 1 is a step diagram of a control method of an education assisting robot according to an embodiment of the present disclosure;

FIG. 2 is a specific step diagram of step S100;

FIG. 3 is a specific step diagram of step S200;

FIG. 4 is a specific step diagram of step S230;

FIG. 5 is another specific step diagram of step S230;

FIG. 6 is another step diagram of an education assisting robot according to an embodiment of the present disclosure; and

FIG. 7 is a structural diagram of an education assisting robot according to an embodiment of the present disclosure.

### DETAILED DESCRIPTION

Specific embodiments of the present disclosure will be described in detail in this section. Preferred embodiments of the present disclosure are shown in the accompanying drawings whose function is to supplement the description of the text part of the specification with graphics, so that each technical feature and the overall technical solution of the present disclosure can be intuitively and vividly understood, but it cannot be construed as limiting the protection scope of the present disclosure.

In the description of the present disclosure, unless otherwise clearly defined, the terms such as dispose, install and connect shall be understood in a broad sense. A person skilled in the art can reasonably determine the specific meanings of the above terms in the present disclosure in combination with specific contents of the technical solution.

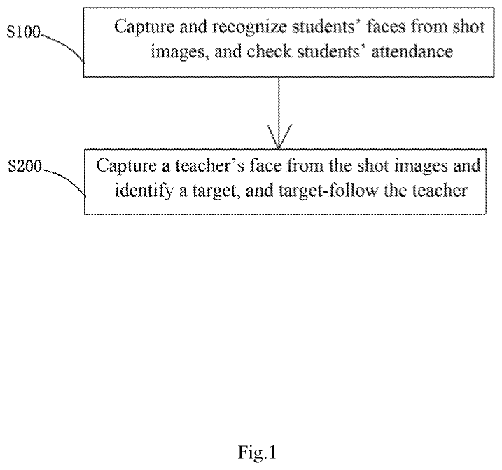

Referring to FIG. 1, a control method of an education assisting robot is provided in an embodiment of the present disclosure, including:

step S100: capturing and recognizing students' faces from shot images, and checking students' attendance; and

step S200: capturing a teacher's face from the shot images and identifying a target, and target-following the teacher.

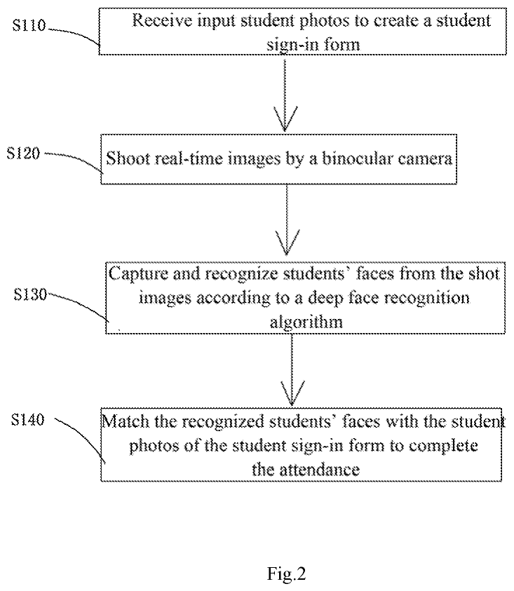

Referring to FIG. 2, further, step S100 includes:

step S110: receiving input students' photos to create a student sign-in form;

step S120: shooting real-time images by a binocular camera;

step S130: capturing and recognizing students' faces from the shot images according to a deep face recognition algorithm; and

step S140: matching the recognized students' faces with the students' photos of the student sign-in form to complete the attendance.

In this embodiment, students walk up to the education assisting robot and point their faces at the binocular camera. The education assisting robot recognizes students' faces from the images and matches the student photos of the student sign-in form to exclude name labels of the students who have signed in from the student sign-in form. After the attendance check is completed, name labels of unsigned students will be displayed on the display module in a form.

Further, step S130 includes:

step S131: texturing the images by using an LBP histogram and extracting face features, wherein the face features are six reference points positioned at the positions on the face, including two points at the position of the eyes, one point at the position of the nose and three points at the position of the mouth;

step S132: performing SVR processing on the face features to obtain 2D-aligned 2D faces;

step S133: Deloni triangulating the faces based on key points of the 2D faces and adding triangles to edges of face contours;

step S134: converting the triangulated faces to 3D faces facing forward; and

step S135: obtaining student face recognition results after face representation, normalization and classification of the 3D faces. The face representation is completed by a CNN network. The structure of the CNN network is as follows: a first layer is a shared convolution layer, a second layer is a max pooling layer, a third layer is a shared convolution layer, fourth to sixth layers are unshared convolution layers, a seventh layer is a full connection layer, and a eighth layer is a softmax classification layer.

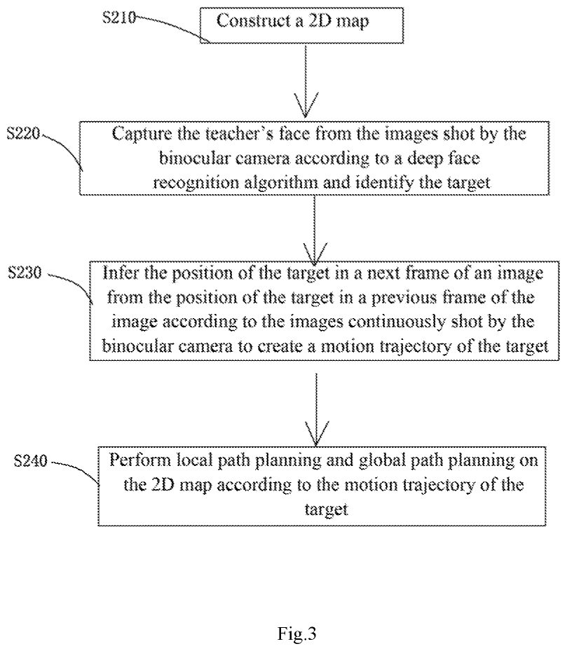

Referring to FIG. 3, further, step S200 includes:

step S210: constructing a 2D map;

step S220: capturing the teacher's face from the images shot by the binocular camera according to a deep face recognition algorithm and identifying the target, wherein the method of capturing and recognizing teacher's faces by a deep face recognition algorithm is the same as that of capturing and recognizing students' faces;

step S230: inferring the position of the target in a next frame of an image from the position of the target in a previous frame of the image according to the images continuously shot by the binocular camera to create a motion trajectory of the target; and

step S240: performing local path planning and global path planning on the 2D map according to the motion trajectory of the target.

Further, step S210 includes:

step S211: acquiring motion attitude and peripheral images of the robot and extracting landmark information from the peripheral images; and

step S212: generating the 2D map according to the motion attitude of the robot and the landmark information.

Specifically, the motion attitude of the robot includes position information and a heading angle. The robot uses GPS satellite positioning to acquire the position information of the robot and uses an angular speed meter to calculate the heading angle of the robot. The peripheral image is obtained from image information around the robot shot by the binocular camera of the robot. Furthermore, the landmark information refers to an object with an obvious landmark in the peripheral image, such as a column, a line or an architectural sign, represented by coordinates (x, y). After all the landmark information is acquired, the 2D map is obtained by closed-loop detection based on position information and landmark information of the robot.

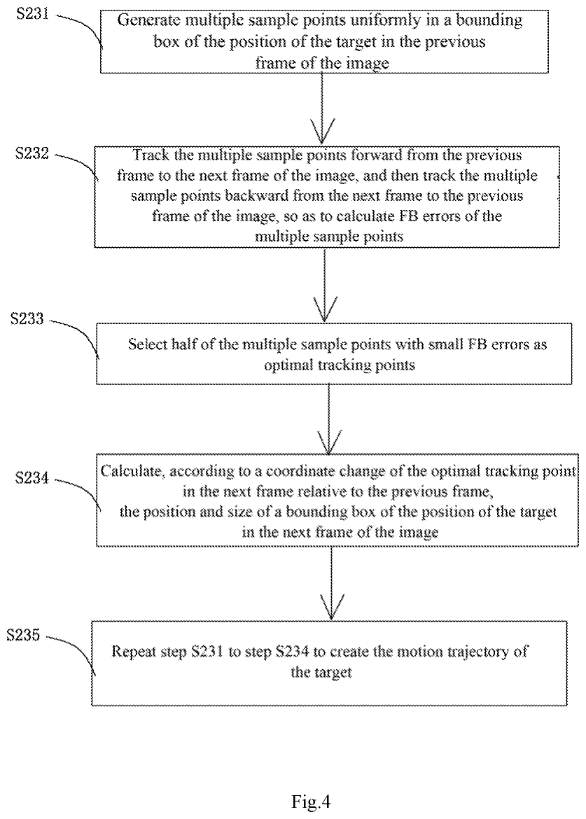

Referring to FIG. 4, further, step S230 includes:

step S231: generating multiple sample points uniformly in a bounding box of the position of the target in the previous frame of the image;

step S232: tracking the multiple sample points forward from the previous frame to the next frame of the image, and then tracking the multiple sample points backward from the next frame to the previous frame of the image, so as to calculate FB errors of the multiple sample points, wherein a sample point starts tracking from an initial position x(t) in the previous frame to produce a position x(t+p) in the next frame, and then tracks reversely from the position x(t+p) to produce a predicted position x′(t) in the previous frame. The Euclidean distance between the initial position and the predicted position is the FB error of the sample point;

step S233: selecting half of the multiple sample points with small FB errors an optimal tracking points;

step S234: calculating, according to a coordinate change of the optimal tracking points in the next frame relative to the previous frame, the position and size of a bounding box of the position of the target in the next frame of the image; and

step S235: repeating the step of obtaining the bounding box of the position of the target in the next frame of the image from the bounding box of the position of the target in the previous frame of the image to create the motion trajectory of the target.

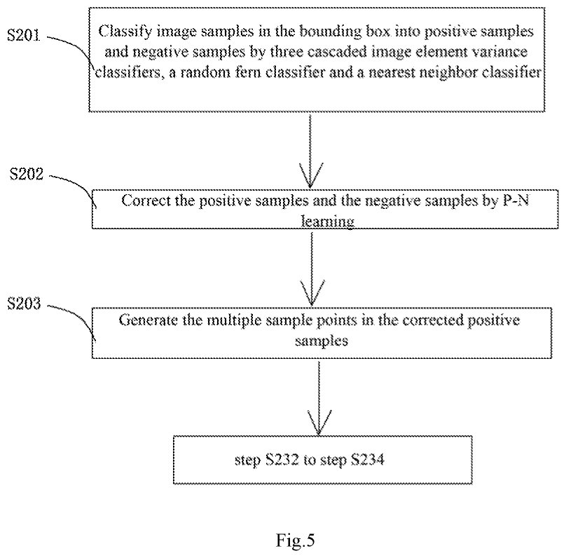

Referring to FIG. 5, further, step S230 further includes:

step S201: classifying image samples in the bounding box into positive samples and negative samples by three cascaded image element variance classifiers, a random fern classifier and a nearest neighbor classifier;

step S202: correcting the positive samples and the negative samples by P-N learning; and

step S203: generating the multiple sample points in the corrected positive samples.

In this embodiment, the image element variance classifier, the random fern classifier and the nearest neighbor classifier calculate variances, judgment criteria and relative similarities of pixel gray values of image samples, respectively. P-N learning is provided with a P corrector that corrects positive samples wrongly classified into negative samples and an N corrector that corrects negative samples wrongly classified into positive samples. The P corrector functions to find a temporal structure of the image samples and ensure that the positions of the target on the consecutive frames can constitute a continuous trajectory. The N corrector functions to find a spatial structure of the image samples, compare original image samples with the image samples corrected by the P corrector, and select a positive sample with the most credible position and ensuring that the target only appears in one position. The multiple sample points are generated in the corrected positive samples, and then the above step of creating a motion trajectory of the target is continued.

Further, the local path planning specifically includes:

obtaining a shape of an obstacle through detection of a distance from the obstacle by a laser sensor and image analysis by the binocular camera; and

identifying a travel speed and a travel direction by a dynamic window approach according to the distance from the obstacle and the shape of the obstacle.

The principle of the dynamic window approach is as follows: the robot arrives at a destination point at a certain speed along a certain direction from a current point, samples multiple groups of trajectories in a (v, w) space, evaluates the multiple groups of trajectories by using an evaluation function, and selects (v, w) corresponding to an optimal trajectory, where v is the magnitude of the speed, which is used for determining the travel speed; and w is the magnitude of the angular speed, which is used for determining the travel direction.

The global path planning specifically includes:

defining multiple nodes in the 2D map; and

obtaining an optimal global path by searching for and identifying a target node directly connected to a current node and having the least travel cost with the current node until the final node is the target node. In this embodiment, the target node having the least travel cost is found by using an A* algorithm.

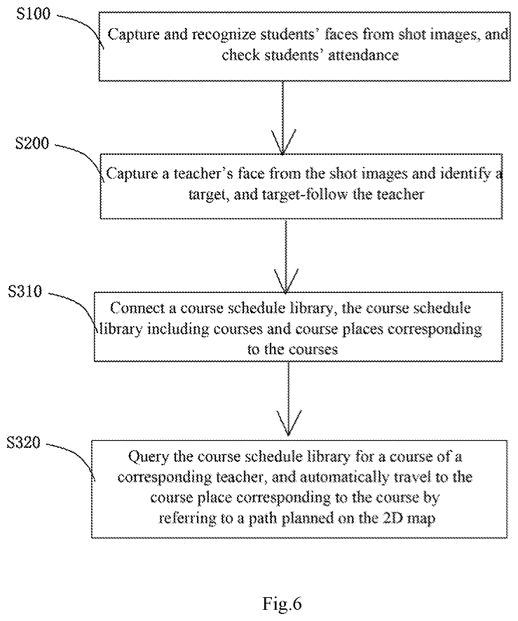

Referring to FIG. 6, further, the control method of an education assisting robot further includes:

step S310: connecting a course schedule library, the course schedule library including courses and course places corresponding to the courses; and

step S320: querying the course schedule library for a course of a corresponding teacher, and automatically traveling to the course place corresponding to the course by referring to a path planned on the 2D map.

In this embodiment, the function of automatically tracking course places is confirmed and the name of a teacher is input. The robot will connect to the course schedule library, find a course schedule corresponding to the teacher, and obtain the nearest course and the course place corresponding to the course. It automatically travels to the course place corresponding to the course by referring to a path planned on the 2D map. The course schedule further includes a students' attendance sheet of the course, which will be checked upon arrival of the students. When the teacher arrives, the teacher is automatically identified and target-followed.

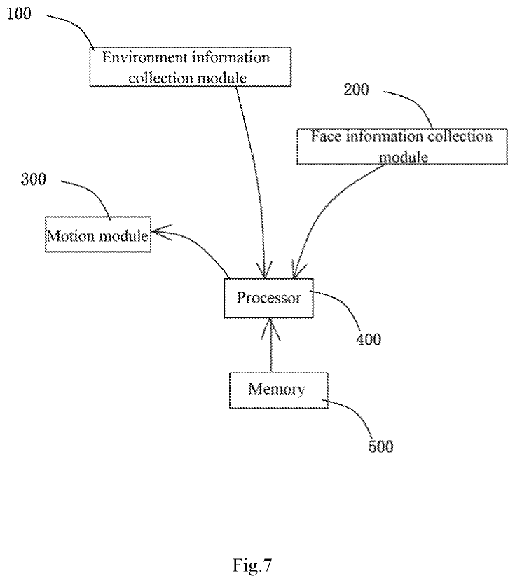

Referring to FIG. 6 and FIG. 7, an education assisting robot applied to the control method is provided in another embodiment of the present disclosure, including an environment information collection module 100, a face information collection module 200, a motion module 300, a processor 400 and a memory 500, wherein the memory 500 stores control instructions, the processor 400 executes the control instructions and controls the environment information collection module 100, the face information collection module 200 and the motion module 300 to perform the following steps:

step S100: capturing and recognizing students' faces from shot images, and checking students' attendance;

step S200: capturing a teacher's face from the shot images and identifying a target, and target-following the teacher; and

step S310 and step S320: connecting a course schedule library, the course schedule library including courses and course places corresponding to the courses; and querying the course schedule library for a course of a corresponding teacher, and automatically traveling to the course place corresponding to the course by referring to a path planned on the 2D map.

Specifically, the environment information collection module 100 includes a laser sensor and a binocular camera, the face information acquisition module 200 includes a binocular camera, and the motion module 300 includes four motion wheels independently driven by motors. In addition, the education assisting robot further includes a touch display screen to display various information and facilitate users to command and operate the education assisting robot.

In this embodiment, the robot can automatically plan a path and travel to a target place. The robot can distinguish the roles of different targets from the images shot by the face information collection module 200, and make different actions according to different roles. It can check attendance of students or control the motion module 300 to move according to environment information collected by the environment information collection module 100 to target-follow teachers. Then, after the teachers are followed, more collaborative functions are implemented according to further instructions of the teachers such as providing a course query function, so as to assist the teachers' work.

A storage medium storing executable instructions is provided in another embodiment of the present disclosure, wherein the executable instructions enable a processor connected to the storage medium to perform the control method to control the motion of the robot.

The above are merely preferred embodiments of the present disclosure, but the present disclosure is not limited to the above implementations. The implementations should all be encompassed in the protection scope of the present disclosure as long as they achieve the technical effect of the present disclosure with the same means.

We claim:

1. A control method of an education assisting robot, comprising:
capturing and recognizing students' faces from shot images, and checking students' attendance; and
capturing a teacher's face from the shot images and identifying a target, and target-following the teacher.

2. The control method of claim 1, comprising:
receiving input student photos to create a student sign-in form;
shooting real-time images by a binocular camera;
capturing and recognizing students' faces from the shot images by a deep face recognition algorithm; and
matching the recognized students' faces with the student photos of the student sign-in form to complete the attendance.

3. The control method of claim 2, comprising:
texturing the images by using an LBP histogram and extracting face features;
performing SVR processing on the face features to obtain 2D-aligned 2D faces;
Deloni triangulating the faces based on key points of the 2D faces and adding triangles to edges of face contours;
converting the triangulated faces to 3D faces facing forward; and
obtaining student face recognition results by face representation, normalization and classification of the 3D faces.

4. The control method of claim 1, comprising:
constructing a 2D map;
capturing the teacher's face from the images shot by the binocular camera by a deep face recognition algorithm, and identifying the target;
inferring, according to the images continuously shot by the binocular camera, a position of the target in a next frame of an image from a position of the target in a previous frame of the image, to create a motion trajectory of the target; and
performing local path planning and global path planning on the 2D map according to the motion trajectory of the target.

5. The control method of claim 4, comprises:
acquiring motion attitude and peripheral images of the robot, and extracting landmark information from the peripheral images; and
generating the 2D map according to the motion attitude of the robot and the landmark information.

6. The control method of claim 4, comprising:
generating multiple sample points uniformly in a bounding box of the position of the target in the previous frame of the image;
tracking the multiple sample points forward from the previous frame to the next frame of the image, and then tracking the multiple sample points backward from the next frame to the previous frame of the image, so as to calculate FB errors of the multiple sample points;
selecting half of the multiple sample points with small FB errors as optimal tracking points;
calculating, according to a coordinate change of the optimal tracking points in the next frame relative to the previous frame, the position and size of a bounding box of the position of the target in the next frame of the image; and
repeating the step of obtaining the bounding box of the position of the target in the next frame of the image from the bounding box of the position of the target in the previous frame of the image to create the motion trajectory of the target.

7. The control method of claim 6, further comprising:
classifying image samples in the bounding box into positive samples and negative samples by three cascaded image element variance classifiers, a random fern classifier and a nearest neighbor classifier;
correcting the positive samples and the negative samples by P-N learning; and
generating the multiple sample points in the corrected positive samples.

8. The control method of claim 4, comprising:
obtaining a shape of an obstacle through detection of a distance from the obstacle by a laser sensor and image analysis by the binocular camera; and
identifying a travel speed and a travel direction by a dynamic window approach according to the distance from the obstacle and the shape of the obstacle; and
the global path planning specifically comprises:
defining multiple nodes in the 2D map; and
obtaining an optimal global path by searching for and identifying a target node directly connected to a current node and having the least travel cost with the current node until the final node is the target node.

9. The control method of claim 4, further comprising:
connecting a course schedule library, the course schedule library comprising courses and course places corresponding to the courses; and
querying the course schedule library for a course of a corresponding teacher, and automatically traveling to the course place corresponding to the course by referring to a path planned on the 2D map.

10. An education assisting robot, applied to the control method of claim 1, comprising an environment information collection module, a face information collection module, a motion module, a processor and a memory, wherein the memory stores control instructions, the processor executes the control instructions and controls the environment information collection module, the face information collection module and the motion module to perform the following steps:
capturing and recognizing students' faces from shot images, and checking students' attendance; and
capturing a teacher's face from the shot images and identifying a target, and target-following the teacher.

11. An education assisting robot, applied to the control method of claim 2, comprising an environment information collection module, a face information collection module, a motion module, a processor and a memory, wherein the memory stores control instructions, the processor executes the control instructions and controls the environment information collection module, the face information collection module and the motion module to perform the following steps:
capturing and recognizing students' faces from shot images, and checking students' attendance; and
capturing a teacher's face from the shot images and identifying a target, and target-following the teacher.

12. An education assisting robot, applied to the control method of claim 3, comprising an environment information collection module, a face information collection module, a motion module, a processor and a memory, wherein the memory stores control instructions, the processor executes the control instructions and controls the environment information collection module, the face information collection module and the motion module to perform the following steps:
capturing and recognizing students' faces from shot images, and checking students' attendance; and
capturing a teacher's face from the shot images and identifying a target, and target-following the teacher.

13. An education assisting robot, applied to the control method of claim 4, comprising an environment information collection module, a face information collection module, a motion module, a processor and a memory, wherein the memory stores control instructions, the processor executes the control instructions and controls the environment information collection module, the face information collection module and the motion module to perform the following steps:
capturing and recognizing students' faces from shot images, and checking students' attendance; and
capturing a teacher's face from the shot images and identifying a target, and target-following the teacher.

14. An education assisting robot, applied to the control method of claim 5, comprising an environment information collection module, a face information collection module, a motion module, a processor and a memory, wherein the memory stores control instructions, the processor executes the control instructions and controls the environment information collection module, the face information collection module and the motion module to perform the following steps:
capturing and recognizing students' faces from shot images, and checking students' attendance; and
capturing a teacher's face from the shot images and identifying a target, and target-following the teacher.

15. An education assisting robot, applied to the control method of claim 6, comprising an environment information collection module, a face information collection module, a motion module, a processor and a memory, wherein the memory stores control instructions, the processor executes the control instructions and controls the environment information collection module, the face information collection module and the motion module to perform the following steps:
capturing and recognizing students' faces from shot images, and checking students' attendance; and
capturing a teacher's face from the shot images and identifying a target, and target-following the teacher.

16. An education assisting robot, applied to the control method of claim 7, comprising an environment information collection module, a face information collection module, a motion module, a processor and a memory, wherein the memory stores control instructions, the processor executes the control instructions and controls the environment information collection module, the face information collection module and the motion module to perform the following steps:
capturing and recognizing students' faces from shot images, and checking students' attendance; and
capturing a teacher's face from the shot images and identifying a target, and target-following the teacher.

17. An education assisting robot, applied to the control method of claim 8, comprising an environment information collection module, a face information collection module, a motion module, a processor and a memory, wherein the memory stores control instructions, the processor executes the control instructions and controls the environment information collection module, the face information collection module and the motion module to perform the following steps:
capturing and recognizing students' faces from shot images, and checking students' attendance; and
capturing a teacher's face from the shot images and identifying a target, and target-following the teacher.

18. An education assisting robot, applied to the control method of claim 9, comprising an environment information collection module, a face information collection module, a motion module, a processor and a memory, wherein the memory stores control instructions, the processor executes the control instructions and controls the environment information collection module, the face information collection module and the motion module to perform the following steps:
capturing and recognizing students' faces from shot images, and checking students' attendance; and
capturing a teacher's face from the shot images and identifying a target, and target-following the teacher.
